(19) United States
(12) Patent Application Publication
(10) Pub. No.: US 2014/0112120 A1
(43) Pub. Date: Apr. 24, 2014

(54) SERVER, CLIENT DEVICE, AND CONTROL METHODS THEREOF

(71) Applicant: SAMSUNG ELECTRONICS CO., LTD., Suwon-si (KR)

(72) Inventors: Sung-kee KIM, Hwaseong-si (KR); Duk-gu SUNG, Yongin-si (KR); Yo-han KIM, Suwon-si (KR); Ga-hyun RYU, Suwon-si (KR); Chun-bae PARK, Suwon-si (KR); Hyun-woo LIM, Seoul (KR); Do-young JOUNG, Seoul (KR)

(73) Assignee: SAMSUNG ELECTRONICS CO., LTD., Suwon-si (KR)

(21) Appl. No.: 13/948,230

(22) Filed: Jul. 23, 2013

(30) Foreign Application Priority Data
Oct. 19, 2012 (KR) 10-2012-0116896

(51) Int. Cl. H04L 1/18

(52) U.S. Cl. CPC H04L 1/189
USPC 370/216

(57) ABSTRACT

A server, a client device, and control methods thereof are provided. The server includes: a communicator which communicates with the client device; and a controller which, if a retransmission request for a previously transmitted real-time data packet is received from the client device, repeatedly retransmits the previously transmitted real-time data packet.

### CROSS-REFERENCE TO RELATED APPLICATION(S)

This application claims priority from Korean Patent Application No. 10-2012-0116896, filed on Oct. 19, 2012, in the Korean Intellectual Property Office, the disclosure of which is incorporated herein by reference in its entirety.

### BACKGROUND

1. Field

Apparatuses and methods consistent with the exemplary embodiments relate to a server, a client device, and control methods thereof, and more particularly, to a server which transmits a real-time data packet, a client device, and control methods thereof.

2. Description of the Related Art

In general, a packet loss may occur in a packet network according to a state of the packet network in a connectionless protocol such as a User Datagram Protocol (UDP). In particular, the packet loss directly deteriorates an image quality in a real-time video transmission application. A method, such as an Application Layer Forward Error Correction (AL-FEC) or packet retransmission, may be used to alleviate the deterioration of the image quality caused by the packet loss.

If restoring is performed by using a FEC method, a larger number of FEC packets are transmitted to improve a lost packet recovery rate, and thus a load applied to a network is increased. Also, the FEC method increases an additional load applied to the network in an environment where a packet loss occurs due to the load on the network. As a result, the FEC method is not appropriate.

In the packet retransmission method, only a lost packet is selectively retransmitted. Therefore, the lost packet is effectively restored without a great effect on the load applied to the network. However, since a time is required to request a retransmission and retransmit a lost data packet, a time delay occurs when restoring the lost packet in comparison with the Al-FEC.

When transmitting a real-time video such as a video call or a video conferencing, a time delay operates as an element hindering Quality of Experience (QoE). Therefore, using a packet retransmission technique is not appropriate. However, the packet retransmission technique is used within a managed time limit in the video call or the video conferencing in an environment where a transmission time is short in a network such as a local network, thereby effectively restoring a lost packet.

However, a client in an existing retransmission method waits for a timeout period until the client transmits one retransmission request message and receives a retransmitted packet. Therefore, if a requested retransmission packet or a retransmitted data packet is lost, the client knows whether a retransmission fails after a predetermined time elapses. In an application in which a time delay allowed by a system is great, for example, Video On Demand (VOD), a retransmission is requested again to try to restore a packet. Alternatively, a plurality of retransmissions are requested until succeeding in restoring a lost packet. However, in an application where a real-time property is emphasized like a video call or a video conferencing, if restoring fails through a one-time retransmission request, a retransmission is requested again to restore a packet. In this case, a time required for restoring becomes longer, and thus a phenomenon such as a screen stop or the like may occur, thereby worsening QoE or the reaction of a user.

### SUMMARY

Exemplary embodiments address at least the above problems and/or disadvantages and other disadvantages not described above. Also, the exemplary embodiments are not required to overcome the disadvantages described above, and an exemplary embodiment may not overcome any of the problems described above.

The exemplary embodiments provide a server, a client device, and a control method thereof.

According to an aspect of the exemplary embodiments, there is provided a server which transmits a real-time data packet to a client device. The server may include: a communicator which communicates with the client device; and a controller which, if a retransmission request for a pre-transmitted real-time data packet is received from the client device, repeatedly retransmits the pre-transmitted (or previously transmitted) real-time data packet.

The retransmission request may be received in a repeated retransmission request packet form.

The communicator may receive information about a transmitted packet loss rate from the device according to a preset event. The controller may determine the number of repeated transmissions of the pre-transmitted real-time data packet based on the information about the transmitted packet loss rate.

The controller may determine the number of repeated transmissions of the pre-transmitted real-time data packet based on information about a preset targeted lost packet recovery rate and the transmitted packet loss rate.

The real-time data packet may be a packet including a video call image.

According to another aspect of the exemplary embodiments, there is provided a client device which receives a real-time data packet from a server. The client device may include: a communicator which communicates with the server; a determiner which determines whether the real-time data packet transmitted from the server is lost; and a controller which, if it is determined that the real-time data packet is lost, repeatedly transmits a retransmission request packet for the lost real-time data packet to the server.

The client device may further include a network state measurer which measures a network state. The controller may calculate a transmitted packet loss rate according to the measured network state and determine the number of repeated transmissions of the retransmission request packet based on the calculated transmitted packet loss rate.

The real-time data packet may be a packet including a video call image.

According to another aspect of the exemplary embodiments, there is provided a communication system which includes a client device and a server transmitting a real-time data packet to the client device. The communication system may include: the client device which repeatedly transmits a retransmission request packet for the lost real-time data packet according to whether the real-time data packet transmitted from the server is lost; and the server which receives the retransmission request packet from the client device to repeatedly transmit the real-time data packet.

The client device and the server may respectively determine the number of repeated transmissions of the retransmission request packet and the number of repeated transmissions of the real-time data packet based on a transmitted packet loss rate.

According to another aspect of the exemplary embodiments, there is provided a control method of a server transmitting a real-time data packet to a client device. The control method may include: receiving a retransmission request for a pre-transmitted real-time data packet from the client device; and repeatedly retransmitting the pre-transmitted real-time data packet.

The retransmission request may be received in a repeated retransmission request packet form.

The control method may further include: receiving information about a transmitted packet loss rate from the client device according to a preset event; and determining the number of repeated transmissions of the pre-transmitted real-time data packet based on the information about the transmitted packet loss rate.

The number of repeated transmissions of the pre-transmitted real-time data packet may be determined based on information about a preset targeted lost packet recovery rate and the transmitted packet loss rate.

The real-time data packet may be a packet including a video call image.

According to another aspect of the exemplary embodiments, there is provided a control method of a client device receiving a real-time data packet from a server. The control method may include: determining whether the real-time data packet transmitted from the server is lost; and if it is determined that the real-time data packet is lost, repeatedly transmitting a retransmission request packet for the lost real-time data packet to the server.

The control method may further include: measuring a network state; and calculating a transmitted packet loss rate according to the measured network state and determining the number of repeated transmissions of the retransmission request packet based on the calculated transmitted packet loss rate.

The real-time data packet may be a packet including a video call image.

According to another aspect of the exemplary embodiments, there is provided a control method of a communication system including a client device and a server transmitting a real-time data packet to the client device. The control method may include: determining if the real-time data packet is lost; repeatedly transmitting a retransmission request packet for the lost real-time data packet to the server based on whether the real-time data packet transmitted from the client device to the server is lost; and if the server receives the retransmission request packet from the client device, repeatedly retransmitting the real-time data packet.

The control method may further include: determining the number of repeated transmissions of the retransmission request packet and the number of repeated transmissions of the real-time data packet based on a transmitted packet loss rate.

As described above, according to the exemplary embodiments, a repeated retransmission request and a retransmission data packet may be used to transmit a media such as a video sensitive to a time delay in order to improve a lost packet recovery rate.

### BRIEF DESCRIPTION OF THE DRAWINGS

The above and/or other aspects will be more apparent by describing certain exemplary embodiments with reference to the accompanying drawings, in which:

FIGS. 1A and 1B are views illustrating a communication system according to an exemplary embodiment;

FIGS. 2A and 2B are block diagrams illustrating a structure of a server according to various exemplary embodiments;

FIGS. 3A and 3B are block diagrams illustrating a structure of a client device according to an exemplary embodiment;

FIG. 3C is a view illustrating a structure of a client device according to an exemplary embodiment.

FIG. 4 is a view illustrating a software configuration stored in a storage;

FIGS. 5A, 5B, and 6 are views illustrating a relation between operations of a server and a client according to various exemplary embodiments;

FIGS. 7A through 7C are graphs and a table illustrating an effect of improving a loss recovery rate according to an exemplary embodiment;

FIG. 8 is a graph illustrating a selection of the number “n” of retransmission request packets and the number “m” of retransmitted data packets for satisfying a retransmission success rate required by a system based on a network packet loss rate according to an exemplary embodiment;

FIGS. 9A and 9B are flowcharts illustrating control methods of a server and a client device according to exemplary embodiments;

FIG. 10 is a flowchart illustrating an operation of a client device in detail according to an exemplary embodiment; and

FIG. 11 is a flowchart illustrating an operation of a server in detail according to an exemplary embodiment.

### DETAILED DESCRIPTION OF THE EXEMPLARY EMBODIMENTS

Exemplary embodiments are described in greater detail with reference to the accompanying drawings.

In the following description, the same drawing reference numerals are used for the same elements even in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, well-known functions or constructions are not described in detail since they would obscure the exemplary embodiments with unnecessary detail.

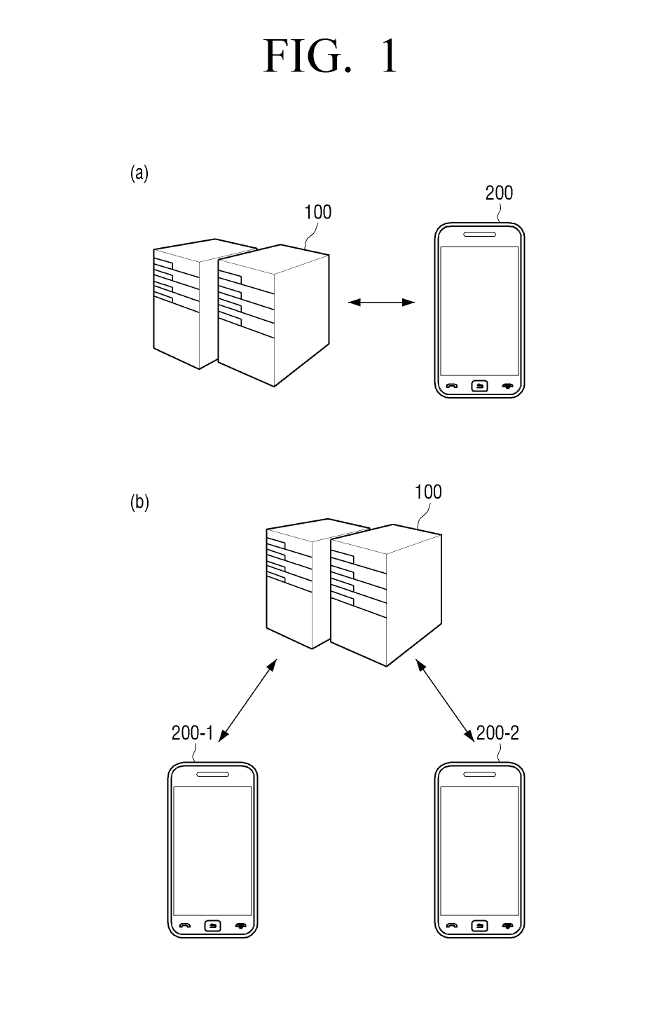

FIGS. 1A and 1B are views illustrating a communication system according to an exemplary embodiment.

Referring to FIG. 1A, the communication system includes a server 100 and a client device 200. Here, the client device 200 may be a portable phone (in particular, a smart phone) as shown in FIG. 1A, but this is only an exemplary embodiment, since the client device is not limited to a smart phone. Therefore, the client device 200 may be realized as various types of electronic devices such as a television (TV), a desktop personal computer (PC), a notebook computer, a tablet PC, etc.

The server 100 and the client device 200 may be connected to each other through a local area network (LAN) and the Internet, through a mobile communication network such as 3G or 4G, or through a short-range wireless communication method such as Bluetooth, a near field communication (NFC), a radio frequency identification (RFID), Zigbee, or the like, according to a realized form of the client device 200.

The server 100 transmits a real-time data packet to the client device 200. In this case, a Realtime Transport Protocol (RTP)/RTP Control Protocol (RTCP) may be used to transmit the real-time data packet. However, any protocol supporting a real-time communication may be applied

According to the RTP/RTCP, an audio or video source is sampled and converted into a digital format, the sampled data is capsulated in an RTP packet, and the RTP packet is capsulated in a network transmission protocol such as a User Datagram Protocol (UDP). The network transmission protocol is capsulated in an IP packet, the IP packet is capsulated in a connection layer protocol, and the connection layer protocol is transmitted.

The real-time data packet transmitted from the server 100 to the client device 200 may be received from another client device 200. For example, the real-time data packet may be a real-time image packet including a video call image received from a video call counterpart device. A communication system according to another exemplary embodiment will now be described with reference to FIG. 1B.

FIG. 1B is a view illustrating a communication system according to another exemplary embodiment.

Referring to FIG. 1B, the communication system may be realized to provide an interaction service, e.g., a video call service. Here, the video call service refers to a service through which participants interact with each other in real time while being able to see each other's face. In the present exemplary embodiment, the video call service includes a video call service where two participants interact with each other in real time while seeing each other's face, and a video call service through which three participants interact with each other in real time while seeing each other's face. However, the exemplary embodiments are not limited thereto, and more than three participants may interact in the video call.

If the interaction service is the video call service, first and second client devices 200-1 and 200-2 may be realized as various types of devices such as a smart phone including a camera and/or a microphone, a tablet computer, a notebook computer, a personal digital assistant (PDA), a portable multimedia player (PMP), a navigation system, a digital TV, and so on.

If the video call service starts according to a request of the first client device 200-1, the first and second client devices 200-1 and 200-2 respectively transmit video call packets to other client devices through the server 100.

In detail, the first client device 200-1 transmits a video call packet generated in real time to the server 100, and the server 100 transmits the video call packet to the second client device 200-2.

In this case, the second client device 200-2 receives a video call packet in which a serial number indicating a generated order is recorded and determines whether the video call packet from the first client device 200-1 is lost, according to the serial number.

If it is determined that the video call packet transmitted from the first client device 200-1 is lost, the second client device 200-2 transmits a retransmission request packet for requesting a retransmission of the lost video call packet to the server 100. In this case, if the server 100 receives the retransmission request packet, the server 100 retransmits the video call packet requested to be retransmitted to the second client device 200-2.

According to an exemplary embodiment, the retransmission request packet transmitted from the second client device 200-2 to the server 100 and the video call packet transmitted from the sever 100 to the second client device 200-2 may be repeatedly transmitted. Structures of the second client device 200-2 and the server 100 will be described in more detail later.

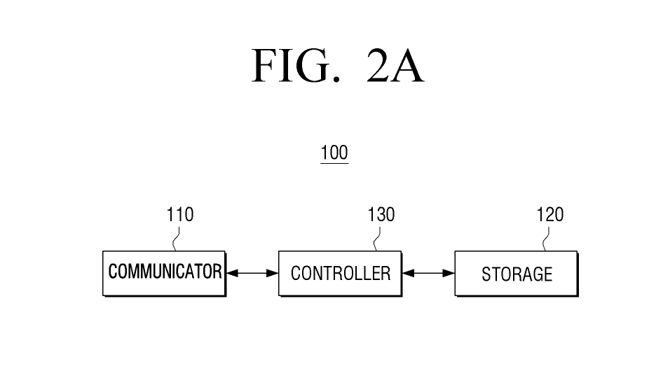

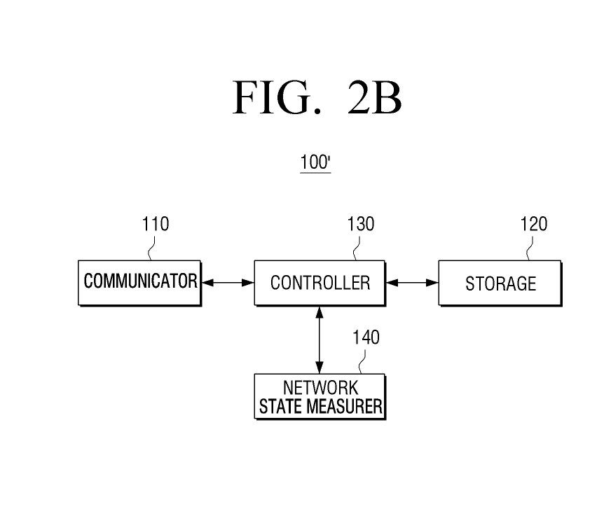

FIGS. 2A and 2B are block diagrams illustrating a structure of the server 100 according to various exemplary embodiments.

The server 100 of the present exemplary embodiment shown in FIG. 2A includes a communicator 110, a storage 120, and a controller 130.

The communicator 110 communicates with the client device 200 to transmit and receive various types of data packets.

The communicator 110 may be connected to the client device 200 through a LAN and the Internet, through a mobile communication network such as 3G or 4G, or through a short-range wireless communication method such as Bluetooth, NFC, Zigbee, or the like.

In detail, the communicator 110 transmits a real-time data packet to the client device 200. Here, the real-time data packet may be a video call packet or a video conferencing packet as described with reference to FIG. 1, but is not limited thereto.

The communicator 110 receives a retransmission request for the real-time data packet from the client device 200. The retransmission request may be received in a packet form, and will be referred to as a retransmission request packet hereinafter. Here, the retransmission request packet may include identification information (e.g., a packet serial number) about a data packet that is an object to be retransmitted. The identification information may be used to sense a packet loss or packet reordering.

The storage 120 stores a real-time data packet received from another client device (not shown). For example, if a real-time video call packet is received from the another client device, the storage 120 may temporarily store a predetermined amount of the real-time video call packet for a preset time so that the real-time video call packet is retransmitted to the client device 200.

The controller 130 controls an overall operation of the server 100.

In detail, if the real-time data packet is received from another client device, the controller 130 controls to transmit the real-time data packet to the client device 200.

If a retransmission request packet for the real-time data packet transmitted to the client device 200 is received, the controller 130 reads the corresponding real-time data packet from the storage 120 and retransmits the corresponding real-time data packet to the client device 200.

In particular, the controller 130 repeatedly retransmits the real-time data packet requested through the received retransmission request packet to the client device 200. In other words, the controller 130 may retransmit the same type of at least two or more real-time data packets according to a retransmission request of the client device 200. In this case, the number of repeatedly retransmitted data packets may be preset or may be determined according to a state of a network as described in a subsequent exemplary embodiment which will be described later. Therefore, there may be an increased probability that a retransmitted real-time data packet will reach the client device 200.

The retransmission request packet received from the client device 200 may be repeatedly received. This considers that a transmission packet loss rate may be equally applied with respect to a retransmission request and will be described in detail later with reference to a block diagram of the client device 200.

According to another exemplary embodiment, the communicator 110 may receive information about a transmission packet loss rate from the client device 200 according to a preset event. In other words, the client device 200 may calculate the transmission packet loss rate based on the serial number included in the real-time data packet received from the server 100 and transmit the information about the transmission packet loss rate to the server 100. Here, the preset event may be a periodical time interval but is not limited thereto. For example, a changed event, etc. of the transmission packet loss rate calculated by the client device 200 may be included in the preset event.

In this case, the controller 130 may determine the number of repeated transmissions of a real-time data packet to be retransmitted based on the information about the received transmission packet loss rate.

For example, if the received transmission packet loss rate is high, the controller 130 may increase the number of repeated retransmissions of the real-time data packet. If the received transmission packet loss rate is low, the controller 130 may decrease the number of repeated retransmissions of the real-time data packet.

The controller 130 may also determine the number of repeated retransmissions of a pre-transmitted real-time data packet based on information about a preset target lost packet recovery rate and a transmission packet loss rate. Here, the preset target lost packet recovery rate refers to a packet recovery rate targeted by the communication system. In other words, the number of repeated retransmissions may not be determined to restore all of lost real-time data packets but may be determined to satisfy the packet recovery rate targeted by the communication system. Therefore, a load rate of a network may be prevented from being unnecessarily increased due to an increase in the number of repeated retransmissions.

In the above-described exemplary embodiment, a transmission packet loss rate is received from the client device 200. However, the server 100 may directly measure the state of the network to measure the transmission packet loss rate.

A server 100′ of another exemplary embodiment shown in FIG. 2B includes a communicator 110, a storage 120, a controller 130, and a network state measurer 140. Detailed descriptions of the same elements of FIG. 2B as those of FIG. 2A will be omitted.

The network state measurer 140 measures a communication network state between the server 100′ and the client device 200.

In detail, the network state measurer 140 may measure the communication network state based on the number of receptions of the retransmission request packet received from the client device 200. For example, if the retransmission request packet is received one time when the real-time data packet is transmitted to the client device 200 five times, the network state measurer 140 may measure or determine that the transmission packet loss rate is 20%.

In this case, the controller 130 may determine the number of repeated transmissions of the real-time data packet to be retransmitted based on information about the measured transmission packet loss rate.

In detail, the controller 130 may determine the number of repeated transmissions of the real-time data packet to be retransmitted based on the preset target lost packet recovery rate and the measured transmission packet loss rate.

The controller 130 may calculate a time delay rate of a packet transmission according to the network state measured by the network state measurer 140 and may determine a retransmission of the pre-transmitted real-time data packet based on the calculated time delay rate. For example, if the time delay rate is high, and thus it is determined that a real-time property is seriously low in restoring a lost packet through a packet retransmission, a corresponding packet may not be retransmitted but may be processed as being lost.

In the above-described exemplary embodiment, one data packet is lost and is re-requested. However, even if the data packet is bust and lost, i.e., the data packet is continuously lost, another exemplary embodiment may be applied.

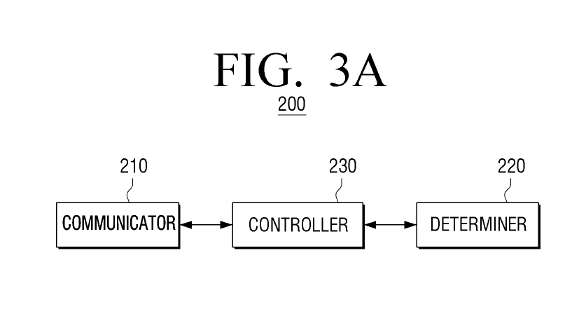

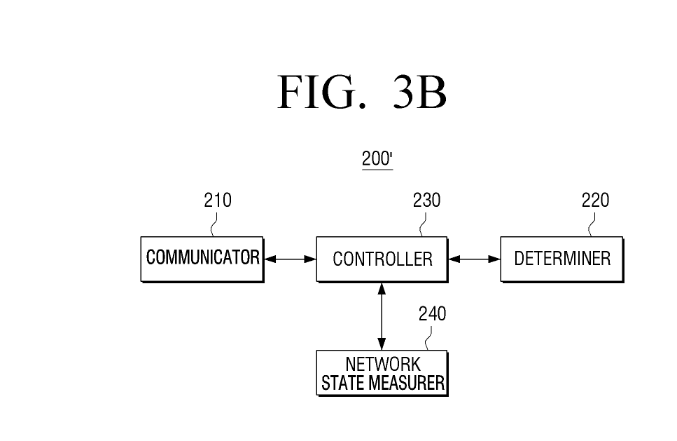

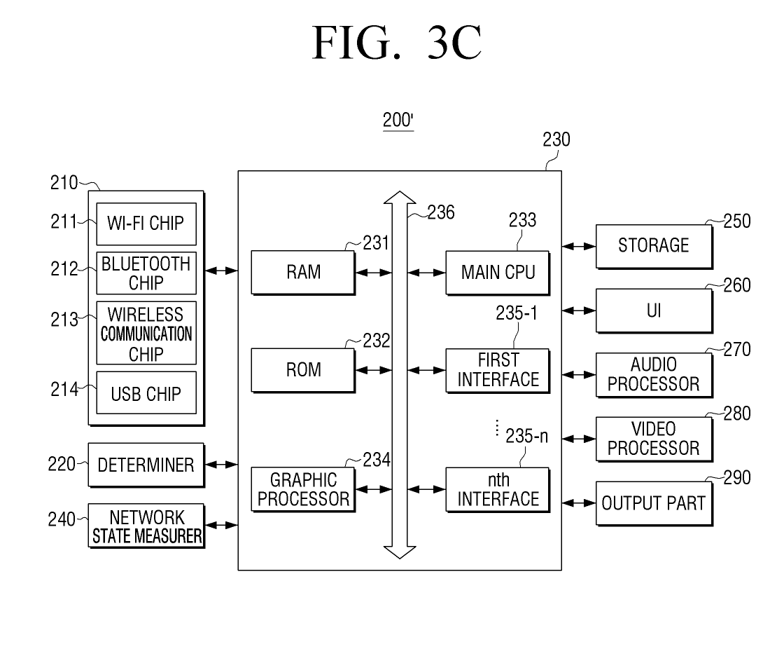

FIGS. 3A through 3C are block diagrams illustrating a structure of a client device according to another exemplary embodiment.

FIG. 3A is a block diagram illustrating a structure of a client device 200 according to an exemplary embodiment.

Referring to FIG. 3A, the client device 200 includes a communicator 210, a determiner 220, and a controller 230.

The communicator 210 communicates with the server 100 to transmit and receive various types of data packets. In this case, the communicator 210 may communicate with the server 100 through various types of communication methods as described above.

In detail, the communicator 210 receives a real-time data packet from the server 100 or transmits the real-time data packet to the server 100. Here, the real-time data packet may be a video call packet or a video conferencing packet as described with reference to FIG. 1 but is not limited thereto.

The communicator 210 transmits a retransmission request packet to the server 100 under control of the controller 230.

The determiner 220 determines whether the real-time data packet transmitted from the server 100 is lost.

In detail, the determiner 220 determines whether a previously transmitted data packet is lost, based on a serial number of the received real-time data packet. For example, if a serial number of a previously received packet is n, and a serial number of a currently received packet is n+2, the determiner 220 may determine that a packet having a serial number n+1 is lost.

The controller 230 controls an overall function of the client device 200.

In particular, if the determiner 220 determines that the real-time data packet transmitted from the server 100 is lost, the controller 230 transmits a retransmission request packet based on the lost real-time data packet to the server 100.

In this case, the controller 230 repeatedly transmits the retransmission request packet. In this case, the number of repeated transmissions of the retransmission request packet may be set to default or may be determined according to a network state as described later.

Therefore, although one of the repeatedly transmitted retransmission request packets is lost when being transmitted, the other retransmission request packets reach the server 100, thereby increasing a probability that a retransmission request will be transmitted to the server 100.

FIG. 3B is a block diagram illustrating a structure of a client device 200′ according to another exemplary embodiment.

Referring to FIG. 3B, the client device 200′ includes a communicator 210, a determiner 220, a controller 230, and a network state measurer 240. Detailed descriptions of the same elements of FIG. 3B as those of FIG. 3A will be omitted herein.

The network state measurer 240 measures a communication network state between the server 100 and the client device 200′.

In detail, the network state measurer 240 measures the communication network state based on whether a real-time data packet received from the server 100 is lost. For example, if the real-time data packet is received from the server 100 four times and is lost one time, the network state measurer 240 may measure that a transmission packet loss rate is 20%.

In this case, the controller 230 determines the number of repeated transmissions of a retransmission request packet based on information about the measured transmission packet loss rate.

FIG. 3C is a block diagram illustrating the structure of the client device 200′ of FIG. 3B according to an exemplary embodiment. Detailed descriptions of the same elements of FIG. 3C as those of FIGS. 3A and 3B will be omitted. However, FIG. 3C illustrates detailed elements of the client device 200′. According to the exemplary embodiments, some of the elements of FIG. 3C may be omitted or changed or other elements may be added. For example, the client device 200′ may further include a global positioning system (GPS) receiver (not shown) which receives a GPS signal from a GPS satellite to calculate a current position of the client device 200′, a digital multimedia broadcasting (DMB) receiver (not shown) which receives and processes a DMB signal, etc.

The communicator 210 is an element which communicates with various types of external devices according to various types of communication methods. The communicator 210 includes various types of chips such as a Wi-Fi chip 211, a Bluetooth chip 212, a wireless communication chip 213, a universal serial bus (USB) chip 214, etc.

The Wi-Fi chip 211 and Bluetooth chip 212 respectively perform communications through a Wi-Fi method and a Bluetooth method. The wireless communication chip 213 refers to a chip which performs a communication according to various types of communication standards such as IEEE, Zigbee, 3rd Generation (3G), 3rd Generation Partnership Project (3GPP), Long Term Evolution (LTE), etc. The USB chip 214 communicates with various types of external devices or performs charging through a USB cable. The communicator 210 may further include an NFC chip which operates according to an NFC method using a bandwidth of 13.56 MHz among various RF-ID frequency bands such as 135 KHz, 13.56 MHz, 433 MHz, 860 MHz to 960 MHz, 2.45 GHz, etc.

The above-described operation of the controller 230 may be performed by a program stored in a storage 250. The storage 250 may store various types of data such as an operating system (O/S) software module for driving the client device 200′, various types of applications, various types of data input or set when executing an application, contents, etc.

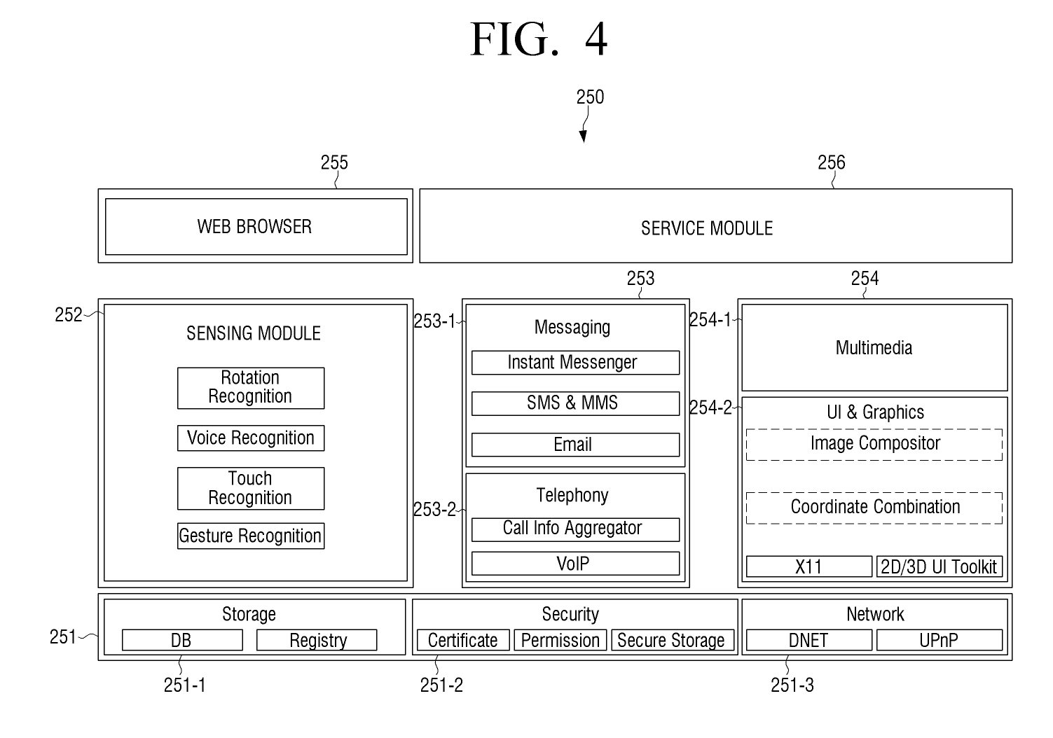

Various types of software modules stored in the storage 250 will be described later with reference to FIG. 4.

A user interface (UI) 260 receives various types of user commands. For example, the UI 260 may receive a user command for performing a communication with the server 100, etc.

An audio processor 270 processes an audio data packet received from the server 100. For example, the audio processor 270 may perform depacketizing with respect to the audio data packet received from the server 100. The audio processor 270 may perform decoding, amplifying, noise-filtering, etc. with respect to various types of audio signals.

A video processor 280 processes a video data packet received from the server 100. For example, the video processor 280 may perform various types of image processing, such as depacketizing, decoding, scaling, noise-filtering, a frame rate conversion, resolution changing, etc., with respect to the video data packet received from the server 100.

An output part 290 outputs audio data and/or video data processed by the audio processor 270 and/or the video processor 280. Therefore, the output part 290 may include a display (not shown) and a speaker (not shown).

The controller 230 controls an overall operation of the client device 200′ by using the various types of programs stored in the storage 250.

For example, the controller 230 may execute a video call application stored in the storage 250 to form and display a video call execution screen or may play various types of contents stored in the storage 250.

In detail, the controller 230 includes a random access memory (RAM) 231, a read only memory (ROM) 232, a main central processing unit (CPU) 233, a graphic processor 234, first through nth interfaces 235-1 through 235-n, a bus 236.

The RAM 231, the ROM 232, the main CPU 233, the graphic processor 234, the first through nth interfaces 235-1 through 235-n are connected to each other through the bus 236.

The first through nth interfaces 235-1 through 235-n are connected to various types of elements as described above. One of the first through nth interfaces 235-1 through 235-n may be a network interface which is connected to the server 100 through a network.

The main CPU 233 accesses the storage 250 to perform booting by suing an O/S stored in the storage 250. The main CPU 255 performs various types of operations by using the various types of programs, contents, and data stored in the storage 250.

The ROM 232 stores a command set for booting the communication system, etc. If a turn-on command is input, and thus power is supplied, the main CPU 233 copies the O/S stored in the storage 250 into the RAM 231 and executes the O/S according to a command stored in the ROM 232 to boot the communication system. If the booting is completed, the main CPU 233 copies the various types of application programs stored in the storage 250 into the RAM 231 and executes the application programs copied into the RAM 231 to perform various types of operations.

The graphic processor 234 generates a screen including various types of objects such as an icon, an image, a text, etc. by using a calculator (not shown) and a renderer (not shown).

FIG. 4 is a block diagram illustrating a software configuration stored in the storage.

Referring to FIG. 4, the storage 250 stores software including a base module 251, a sensing module 252, a communication module 253, a presentation module 254, a web browser module 255, and a service module 256.

The base module 251 processes signals transmitted from hardware of the client device 200 and transmit the processed signals to an upper layer module. The base module 251 includes a storage module 251-1, a security module 251-2, and a network module 251-3. The storage module 251-1 is a program module which manages a database (DB) or a registry. The main CPU 233 accesses the DB of the storage 250 by using the storage module 251-1 to read various types of data. The security module 251-2 is a program module which supports a certification, a permission, a secure storage, etc. of the hardware. The network module 251-3 supports a network connection and includes a DNET module, an UPnP module, etc.

The sensing module 252 collects information from various types of sensors, and parses and manage the collected information. The sensing module 252 may include a face recognizing module (not shown), a voice recognizing module, a motion or gesture recognizing module, a near field communication (NFC) recognizing module (not shown), a rotation recognition module, a touch recognition module, etc.

The communication module 253 performs a communication with an external device. The communication module 253 may include a messaging module 253-1, such as a video call program, a messenger program, a short message service (SMS) & multimedia message service (MMS) program, an e-mail program, or the like, and a telephone module 253-2 including a call info aggregator program module, a VoIP module, etc.

The presentation module 254 forms a display screen. The presentation module 254 includes a multimedia module 254-1 for playing and outputting a multimedia content and a UI rendering module 254-2 for performing a UI and graphic processing. The multimedia module 254-1 may include a player module (not shown), a camcorder module (not shown), a sound processor module (not shown), etc. Therefore, the multimedia module 254-1 plays various types of multimedia contents and generates and display a screen and plays a sound. The UI rendering module 254-2 may include an image compositor module, a coordinate combiner module, an X11 module, a 2-dimensional (2D)/3-dimensional (3D) UI toolkit, etc. The image compositor module combines images, and the coordinate combiner module combines and generates coordinates on a screen which is to display an image. The X11 module receives various types of events from the hardware, and the 2D/3D UI toolkit provides a tool for forming a 2D or 3D UI.

The web browser module 255 performs web browsing to access a web server. The web browser module 255 may include various types of modules such as a web view module which forms a web page, a download agent module which performs downloading, a bookmark module, a webkit module, etc.

The service module 256 includes various types of applications for providing various types of services. In detail, the service module 256 may include various types of program modules such as a navigation program, a content play program, a game program, an e-book program, a calendar program, an alarm management program, other widgets, etc.

Various types of program modules are shown in FIG. 4, but some of the various types of program modules may be omitted, changed, or added according a type and a characteristic of a client device. For example, a position-based module may be further included to operate along with hardware such as a GPS chip in order to support a position-based service.

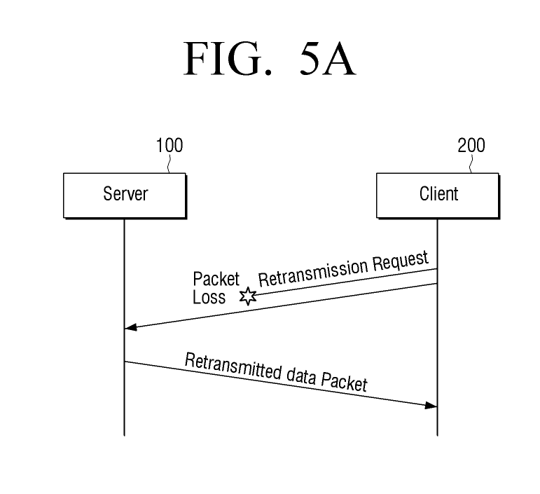

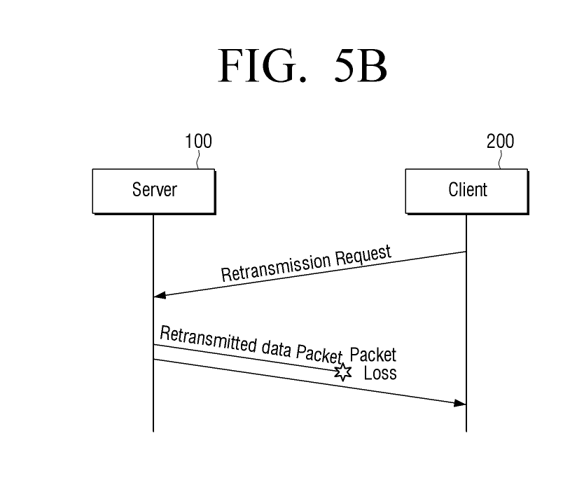

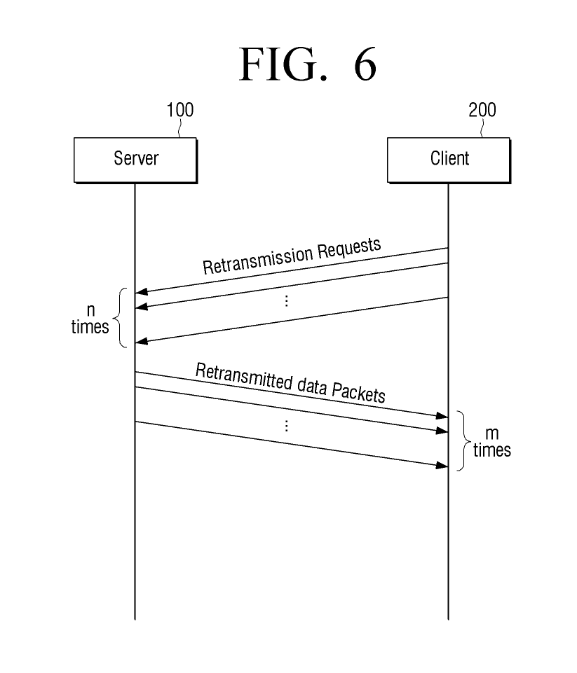

FIGS. 5A, 5B, and 6 are views illustrating a relation between operations of the server 100 and the client 200 according to various exemplary embodiments.

In general, the number of lost packets increases if there is an increase in the packet loss rate of a network, thereby increasing the number of retransmission request packets and the number of retransmitted data packets for restoring the lost packets. In an application emphasizing a real-time property using a packet retransmission method, a delay time allowed by a system is short, and thus only a one-time retransmission is requested. In this case, if a retransmission fails, a retransmission request packet may be lost or a retransmitted data packet may be lost. Therefore, in order to increase a recovery rate through a retransmission, a probability that a retransmission request packet will be lost and a probability that a retransmitted data packet will be lost are to be lowered.

FIG. 5A is a view illustrating a method of lowering a loss probability of a retransmission request packet according to an exemplary embodiment.

As shown in FIG. 5A, if the same type of at least two or more retransmission request packets are simultaneously repeatedly transmitted to lower a loss probability of a retransmission request packet, one of the retransmission request packets is lost. Even in this case, the retransmission request packet reaches the server 100, and thus a retransmission is successfully performed.

FIG. 5B is a view illustrating a method of lowering a loss probability of a retransmitted data packet according to an exemplary embodiment.

As shown in FIG. 5B, the same type of at least two or more retransmitted data packets are repeatedly transmitted. Therefore, although one of the retransmitted data packets is lost, a probability that the other one will successfully reach the client device 200 becomes higher.

As shown in FIGS. 5A and 5B, a retransmission request packet and a retransmitted data packet are repeatedly transmitted to improve a retransmission success rate.

FIG. 6 is a view illustrating a method of simultaneously lowering loss probabilities of a retransmission request packet and a retransmitted data packet according to another exemplary embodiment.

According to the present exemplary embodiment, in order to reduce a retransmission failure rate of a data packet, a retransmission request packet is transmitted “n” times, and a retransmitted data packet is transmitted “m” times as shown in FIG. 6. In this case, a lost packet recovery rate will now be described.

If a packet loss rate in a network, i.e., a probability that a packet will be lost is “p”, a probability that a retransmission request packet gets from the client device 200 to the server 100 one or more times is expressed as in Equation 1 below:

Probability that retransmission request packet reaches server one or more times=1−pⁿ (1)

Also, a probability that a retransmitted data packet gets from the server 100 to the client device 200 one or more times is expressed as in Equation 2 below:

Probability that retransmitted data packet will get from server to client device one or more times=1−p^{m} (2)

Therefore, a probability that a packet retransmission will succeed, i.e., a lost packet recovery rate, is expressed as in Equation 3 below, based on Equations 1 and 2:

Lost packet restoration rate=(1−pⁿ)(1−p^{m}) (3)

In this case, it is assumed that a network time delay is a degree of enabling a retransmission, and it is assumed that a packet loss randomly occurs.

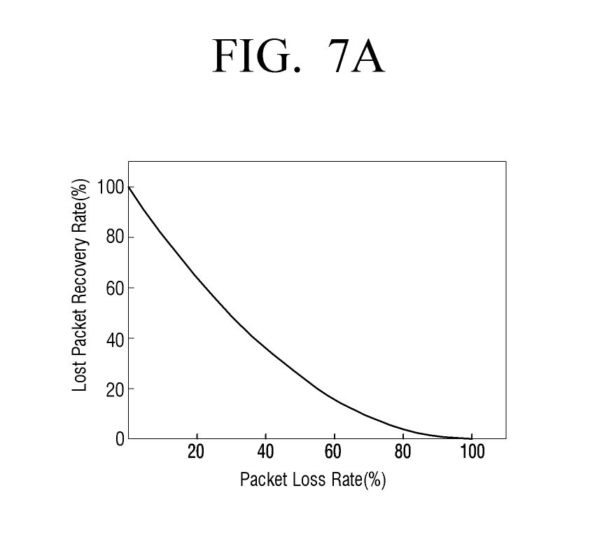

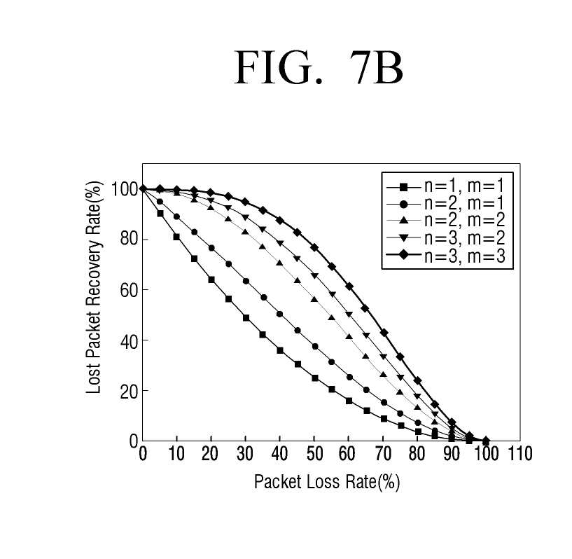

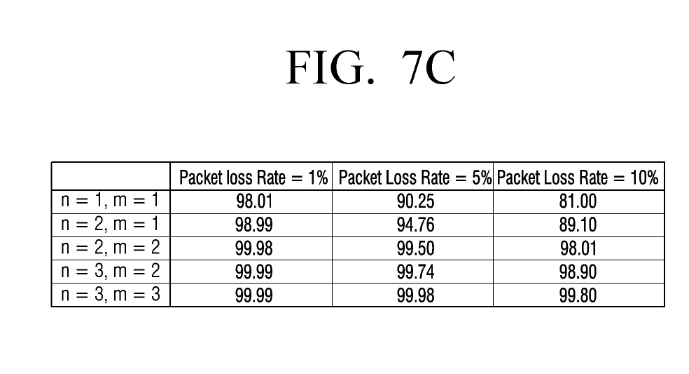

FIGS. 7A through 7C are graphs and a table illustrating an effect of improving a lost packet recovery rate according to an exemplary embodiment.

FIG. 7A is a graph illustrating a relation between a packet loss rate and a lost packet recovery rate for helping an understanding of the exemplary embodiments.

As shown in FIG. 7A, a probability (i.e., a lost packet recovery rate) that a packet retransmission will succeed decreases in an increase in a network packet loss rate.

FIGS. 7B and 7C are respectively a graph and a table illustrating a relation between a packet loss rate and a lost packet recovery rate with respect to the numbers of retransmission request packets and retransmitted data packets according to various exemplary embodiments.

As shown in FIGS. 7B and 7C, if a network packet loss rate is 5%, n=1, and m=1 (the number of retransmission request packets is 1, and the number of retransmitted data packets is 1), a lost packet recovery rate is about 90.25%. This means that 9.75% of a lost packet is not recovered. However, n=2, and m=2, about 99.5% of the lost packet may be recovered. If n=3, and m=3, the lost packet recovery rate may be about 99.98%. In other words, a probability that a retransmission will succeed, or a recovery rate of a lost packet may be greatly improved if there is an increase in a network packet loss rate, i.e., an increase in the number “n” of retransmission request packets or the number “m” of retransmitted data packets.

A repeated retransmission request packet or a retransmitted data packet is repeatedly used to improve a recovery rate of a lost packet according to a retransmission method, but a network load is also increased. Also, the recovery rate of the lost packet increases with an increase in the number of repeatedly retransmitted data packets, but the network load is further increased. For example, if the network packet loss rate is 5%, and the number of retransmitted data packets is 1, about 5% (i.e., 1×5%) of the network load is increased. If the number of retransmitted data packets is 3, about 15% (i.e., 3×5%) of the network load is increased. If a repeated retransmission is used, a lost packet recovery rate is to be maintained as in Equation 3 above. For this purpose, repeated retransmission coefficients “n” and “m” increase with an increase in the network packet loss rate “p”. This is because when the network packet loss rate is low, the number of retransmitted data packets used to maintain a desired recovery rate is low, and thus the network load is reduced.

Therefore, a packet loss rate of a network is periodically measured, and the number of packets to be repeatedly retransmitted is adjusted by using the packet loss rate in order to reduce a load of the network. In other words, if the packet loss rate of the network is low, a small number “n” of retransmission request packets and a small number “m” of retransmitted data packets are used. If the packet loss rate of the network is high, a larger numbers “n” of retransmission request packets and a larger number “m” of retransmitted data packets are used.

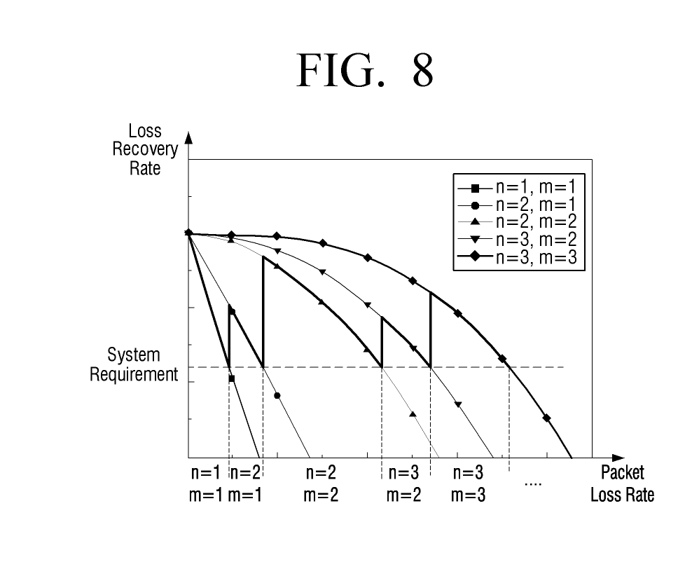

FIG. 8 is a graph illustrating a selection of the number “n” of retransmission request packets and the number “m” of retransmitted data packets for satisfying a retransmission success rate required by a system based on a network packet loss rate according to an exemplary embodiment.

If the network packet loss rate is low, the numbers “n” and “m” are each 1. If the network loss rate is increased and thus does not satisfy a loss recovery rate requested by a system, n=2, and m=1. If the network packet loss rate is further increased, the larger numbers “n” and “m” are used as shown in FIG. 8 to satisfy the loss recovery rate requested by the system. The numbers “n” and “m” may be limited or adjusted according to a load of a network.

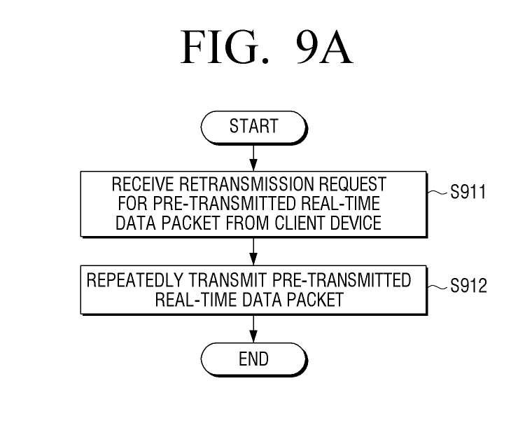

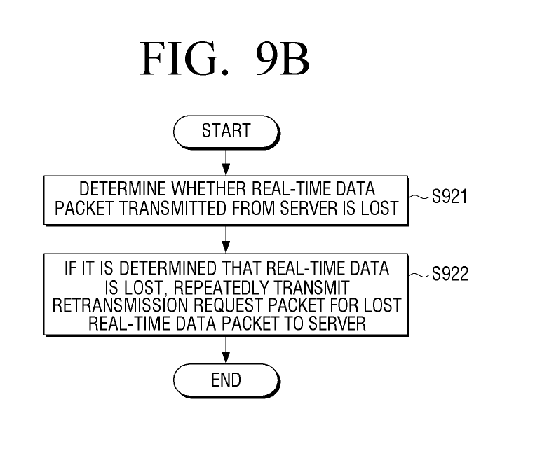

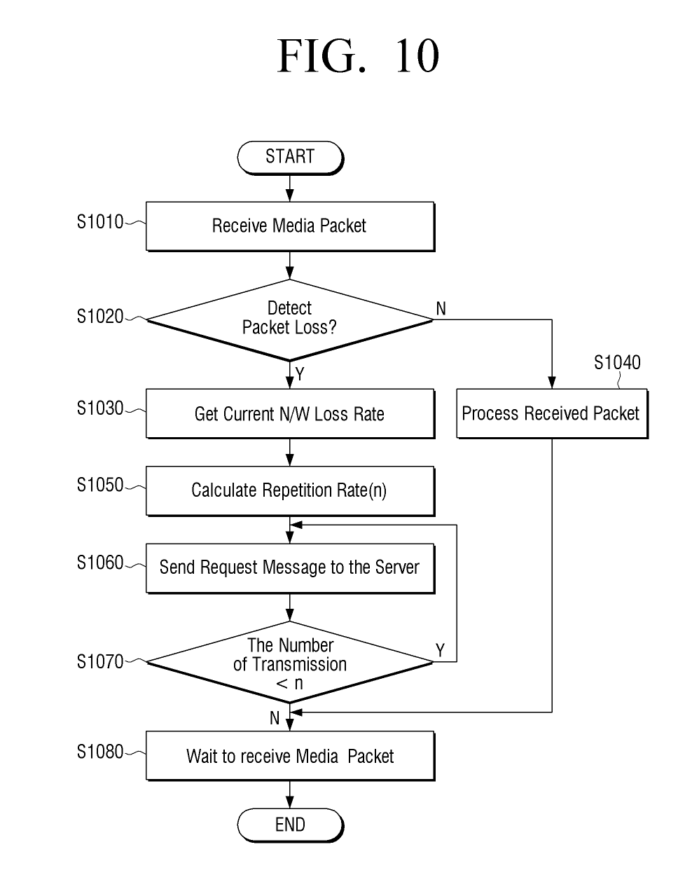

FIGS. 9A and 9B are flowcharts illustrating control methods of a server and a client device according to an exemplary embodiment.

According to the control method shown in FIG. 9A, in operation S911, the server 100 receives a retransmission request for a pre-transmitted (or previously transmitted) real-time data packet from the client device 200. Here, the retransmission request may be received in a repeated retransmission request packet form, and may include identification information (e.g., a packet serial number) about a packet that is an object requested to be retransmitted.

In operation S912, the server 100 repeatedly retransmits the pre-transmitted real-time data packet corresponding to the retransmission request to the client device 200.

The server 100 may also receive information about a transmitted packet loss rate from the client device 200 according to a preset event. The preset event may be a preset time interval, but is not limited thereto. In this case, the server 100 may determine the number of repeated retransmissions of the pre-transmitted real-time data packet based on the information about the transmitted packet loss rate. In detail, the server 100 may determine the number of repeated transmissions of the pre-transmitted real-time data packet based on information about a lost packet recovery rate targeted by a system, and a transmitted packet loss rate. However, the server 100 may measure the transmitted packet loss rate.

The real-time data packet transmitted from the server 100 to the client device 200 may be a packet including a video call image, but is not limited thereto.

According to the control method of the client device 200 shown in FIG. 9B, in operation S921, the client device 200 determines whether a real-time data packet transmitted from the server 100 is lost.

If it is determined in operation S921 that the real-time data packet is lost, the client device 200 repeatedly transmits a retransmission request packet for the real-time data packet to the server 100 in operation S922.

The client device 200 may also measure a network state and calculate a transmitted packet loss rate according to the measured network state. The client device 200 may determine the number of repeated transmissions of the retransmission request packet based on information about the transmitted packet loss rate. The client device 200 may transmit the information about the transmitted packet loss rate to the server 100. Therefore, the server 100 may determine the number of repetitions of a data packet to be retransmitted by using the corresponding information.

The real-time data packet that the client device 200 receives from the server 100 may be a packet including a video call image, but is not limited thereto.

Although not shown in the drawings, in a communication system which includes a client device and a server transmitting a real-time data packet to the client device, according to an exemplary embodiment, the client device repeatedly transmits a retransmission request packet for the lost real-time data packet according to whether the real-time data packet transmitted from the server is lost. If the server receives the retransmission request packet from the client device, the server repeatedly retransmits the real-time data packet corresponding to the retransmission request packet. In this case, the client device and the server may respectively determine the numbers of repeated transmissions of the retransmission request packet and the real-time data packet based on a transmitted packet loss rate measured by the client device or the server.

FIG. 10 is a flowchart illustrating an operation of a client device 200′ according to an exemplary embodiment. Here, the client device 200′ may be the client device 200′ shown in FIG. 3B.

Referring to FIG. 10, in operation S1010, the client device 200′ receives at least one media data packet from the server 100. In operation S1020, the client device 200′ determines whether a media data packet is lost. In detail, the client device 200′ may check whether the media data packet is lost, by using a serial number of the received media data packet.

If it is determined in operation S1020 that the media data packet is not lost, the client device 200′ waits to receive a next media data packet in operation S1040.

If it is determined in operation S1020 that the media data packet is lost, the client device 200′ determines a current packet loss rate and a packet recovery rate in operation S1030. In operation S1050, the client device 200′ determines the repetition number “n” of a request message based on the current packet loss rate and the packet recovery rate. In operation S1060, the client device 200′ transmits a request message to the server 100.

In operation S1070, the client device 200′ counts the number of transmitted request messages to determine whether the number of transmitted request messages is greater than the repetition number “n” of the request message. If it is determined in operation S1070 that the number of transmitted request messages is smaller than the repetition number “n” of the request message, the client device 200′ continuously transmits the request message to the server 100 in operation S1060.

If it is determined in operation S1070 that the number of transmitted request messages is equal to the repetition number “n” of request message, the client device 200′ stops transmitting the request message and waits to receive a media data packet in operation S1080.

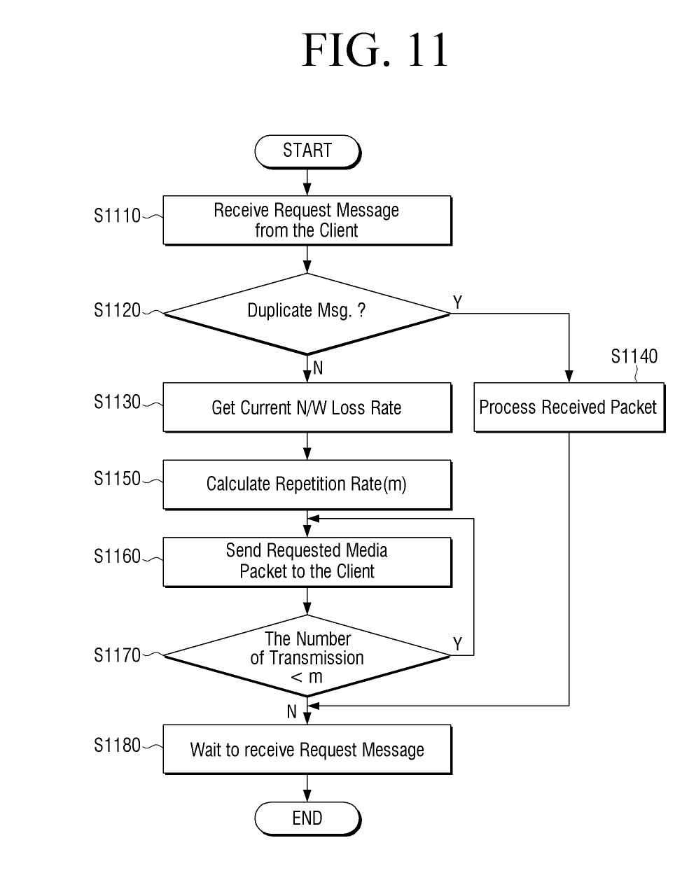

FIG. 11 is a flowchart illustrating a detailed operation of the server 100 according to an exemplary embodiment.

Referring to FIG. 11, in operation S1110, the server 100 receives a retransmission request message for a media packet from the client device 200′. In operation S1120, the server 100 determines whether the received request message is duplicated.

If it is determined in operation S1120 that the request message is duplicated, the server 100 processes a received packet in operation S1140.

If it is determined in operation S1120 that the request message is not duplicated, the server 100 acquires current packet loss rate and packet recovery rate. In operation S1150, the server 100 determines the repetition number “m” of data packets based on the current packet loss rate and packet recovery rate.

In operation S1160, the server 100 transmits a requested media packet to the client device 200′

In operation S1170, the server 100 counts the number of transmitted media packets to determine whether the number of transmitted media packets is smaller than the repetition number “m” of data packets. If it is determined in operation S1170 that the number of transmitted packets is smaller than the repetition number “m” of data packets, the server 100 returns to operation S1160 to continuously transmit the media packet to the client device 200′.

If it is determined in operation S1170 that the number of transmitted packets is equal to the repetition number “m” of data packets, the server 100 stops transmitting the media packet and waits to receive another retransmission request message in operation S1180.

As described above, according to the exemplary embodiments, a duplicated retransmission request and repeated retransmission data packets are used to transmit a media such as a video, sensitive to a time delay, thereby improving a recovery rate of a lost packet. Therefore, since there is no need to wait for a timeout time, the delay time is reduced. Also, in a system capable of sensing a packet loss rate of a network, the appropriate number of packets to be duplicated is used to reduce a load of the network.

The control methods according to the above-described exemplary embodiments may be realized as programs, and then provided to a server or a client device.

For example, a non-transitory computer readable medium, which stores a program performing: receiving a retransmission request for a pre-transmitted real-time data packet from the client device; and duplicating and transmitting the pre-transmitted real-time data packet, may be provided to the server.

As another example, a non-transitory computer readable medium, which stores a program for determining whether a real-time data packet transmitted from the server is lost; and if it is determined that the real-time data packet is lost, duplicating and transmitting a retransmission request packet for the lost real-time data packet to the server, may be provided to the client device.

The non-transitory computer readable medium refers to a medium which does not store data for a short time such as a register, a cache memory, a memory, or the like but semi-permanently stores data and is readable by a device. In detail, the above-described applications or programs may be stored and provided on a non-transitory computer readable medium such as a CD, a DVD, a hard disk, a blue-ray disk, a universal serial bus (USB), a memory card, a ROM, or the like.

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A server configured to transmit a real-time data packet to a client device, the server comprising:
a communicator, configured to communicate with the client device; and
a controller configured to, if a retransmission request for a previously transmitted real-time data packet is received from the client device, repeatedly retransmit the previously transmitted real-time data packet.

2. The server of claim 1, wherein the retransmission request is received in a repeated retransmission request packet form.

3. The server of claim 1, wherein the communicator receives information about a transmitted packet loss rate from the client device based on a preset event, and
wherein the controller is configured to determine a number of repeated transmissions of the previously transmitted real-time data packet based on the information about the transmitted packet loss rate.

4. The server of claim 3, wherein the controller is configured to determine the number of repeated transmissions of the previously transmitted real-time data packet based on information about a preset targeted lost packet recovery rate and the transmitted packet loss rate.

5. The server of claim 1, wherein the real-time data packet is a packet comprising a video call image.

6. A client device configured to receive a real-time data packet from a server, the client device comprising:
a communicator, configured to communicate with the server;
a determiner, configured to determine whether the real-time data packet transmitted from the server is lost; and
a controller, configured to, if it is determined that the real-time data packet is lost, repeatedly transmit a retransmission request packet for the lost real-time data packet to the server.

7. The client device of claim 6, further comprising:
a network state measurer, configured to measure a network state,
wherein the controller is configured to calculate a transmitted packet loss rate based on the measured network state and determine a number of repeated transmissions of the retransmission request packet based on the calculated transmitted packet loss rate.

8. The client device of claim 6, wherein the real-time data packet is a packet comprising a video call image.

9. A communication system which comprises a client device and a server transmitting a real-time data packet to the client device, the communication system comprising:
the client device is configured to determine if a real-time data packet is lost, and repeatedly transmit a retransmission request packet for the lost real-time data packet according to whether it is determined that the real-time data packet transmitted from the server is lost; and
the server configured to receive the retransmission request packet from the client device to repeatedly transmit the real-time data packet.

10. The communication system of claim 9, wherein the client device and the server are respectively configured to determine a number of repeated transmissions of the retransmission request packet and a number of repeated transmissions of the real-time data packet based on a transmitted packet loss rate.

11. A control method of a server transmitting a real-time data packet to a client device, the control method comprising:
receiving a retransmission request for a previously transmitted real-time data packet from the client device; and
repeatedly retransmitting the previously transmitted real-time data packet to the client device.

12. The control method of claim 11, wherein the retransmission request is received in a repeated retransmission request packet form.

13. The control method of claim 11, further comprising:
receiving information about a transmitted packet loss rate from the client device according to a preset event; and
determining a number of repeated transmissions of the previously transmitted real-time data packet based on the information about the transmitted packet loss rate.

14. The control method of claim 13, wherein the number of repeated transmissions of the previously transmitted real-time data packet is determined based on information about a preset targeted lost packet recovery rate and the transmitted packet loss rate.

15. The control method of claim 11, wherein the real-time data packet is a packet comprising a video call image.

16. A control method of a client device receiving a real-time data packet from a server, the control method comprising:
determining whether the real-time data packet transmitted from the server is lost; and
if it is determined that the real-time data packet is lost, repeatedly transmitting a retransmission request packet for the lost real-time data packet to the server.

17. The control method of claim 16, further comprising:
measuring a network state; and
calculating a transmitted packet loss rate based on the measured network state and determining a number of repeated transmissions of the retransmission request packet based on the calculated transmitted packet loss rate.

18. The control method of claim 16, wherein the real-time data packet is a packet comprising a video call image.

19. A control method of a communication system comprising a client device and a server transmitting a real-time data packet to the client device, the control method comprising:
determining if the real-time data packet transmitted from the server is lost;
repeatedly transmitting a retransmission request packet for the lost real-time data packet to the server according to whether the real-time data packet transmitted from the client device to the server is lost; and
if the server receives the retransmission request packet from the client device, repeatedly retransmitting the real-time data packet.

20. The control method of claim 19, further comprising:
determining a number of repeated transmissions of the retransmission request packet and the number of repeated transmissions of the real-time data packet based on a transmitted packet loss rate.

21. A method of receiving, by a client device, packets transmitted from a server, the method comprising:
receiving at least one real-time data packet from the server;
determining if a real-time data packet transmitted from the server is lost;
determining a current packet loss rate and a packet recovery rate if it is determined that a real-time data packet is lost;
determining a repetition number of a retransmission request message based on the determined packet loss rate and the determined packet recovery rate; and
transmitting the retransmission request message to server to request retransmission of the lost real-time data packet.

22. The method of claim 21, wherein the retransmission request message is transmitted to the server a number of times that is equal to the repetition number.

23. The method of claim 21, wherein the real-time data packet is determined to be lost based on a serial number of the real-time data packets.

24. The method of claim 21, wherein the real-time data packet is video-call data.
